(19) United States
(12) Patent Application Publication
(10) Pub. No.: US 2026/0085931 A1
(43) Pub. Date: Mar. 26, 2026

(54) HOLOGRAM FOR AIDING TELESCOPE ALIGNMENT

(71) Applicant: Arizona Optical Metrology LLC, Tucson, AZ (US)

(72) Inventors: Cormic K. Merle, Rochester, NY (US); James Burge, Tucson, AZ (US); Edward LaVilla, New Haven, CT (US); Shelby Ament, Vail, AZ (US)

(73) Assignee: Arizona Optical Metrology LLC, Tucson, AZ (US)

(21) Appl. No.: 19/338,722

(22) Filed: Sep. 24, 2025

Related U.S. Application Data
(60) Provisional application No. 63/699,041, filed on Sep. 25, 2024.

(51) Int. Cl. G01B 11/27; G02B 23/02; G02B 27/34

(52) U.S. Cl. CPC G01B 11/272; G02B 23/02; G02B 27/34

(57) ABSTRACT

A telescope is aligned with a wavefront sensor and a single hologram, e.g., Computer Generated Holograms (CGH), at the input of the telescope, in object space, that ensures that the chief ray angle of the input wavefront is aligned to the primary mirror axis. Additionally, the hologram can be used to ensure that a system return optic, used to retroreflect the rays back through the telescope and to the wavefront sensor, is located along the primary mirror axis and is at the correct distance from the primary mirror vertex. With the input wavefront and system return optic properly aligned to the primary mirror the secondary mirror can be aligned to the primary mirror via a simple measurement of the telescope wavefront at a single field angle or at multiple field angles.

### CLAIM OF PRIORITY

This application claims the benefit of and priority to U.S. Provisional Application No. 63/699,041, filed Sep. 25, 2024, and entitled “HOLOGRAM FOR AIDING TELESCOPE ALIGNMENT,” which is assigned to the assignee hereof and is incorporated herein by reference in its entirety.

### FIELD OF THE DISCLOSURE

The subject matter described herein is related generally to telescope systems, and more particularly to telescope alignment.

### BACKGROUND

Telescope system alignment via traditional methods requires a significant amount of data to be collected and analyzed to determine if the alignment is correct. This is because it is possible to align the telescope in ways that result in good performance at one field angle but quickly drops in performance at other field angles due to field dependent astigmatism. The process to prevent such an alignment condition involves multiple hardware configurations and at least one experienced engineer to analyze the data and make corrections.

Advanced telescope alignment processes are typically attended by a high cost and multiple alignment steps, which may be complicated and time consuming. Additionally, some telescopes are not well suited for advanced telescope alignment approaches. Accordingly, a low-cost and simple alignment method is desirable.

### SUMMARY

A telescope is aligned with a wavefront sensor and a single hologram, e.g., Computer Generated Holograms (CGH) at the input of the telescope, in object space, that ensures that the chief ray angle of the input wavefront is aligned to the primary mirror axis. Additionally, the hologram can be used to ensure that a system return optic, used to retroreflect the rays back through the telescope and to the wavefront sensor, is located along the primary mirror axis and is at the correct distance from the primary mirror vertex. With the input wavefront and system return optic properly aligned to the primary mirror the secondary mirror can be aligned to the primary mirror via a simple measurement of the telescope wavefront at a single field angle or at multiple field angles.

In one implementation, an alignment system for aligning a telescope includes a wavefront sensor configured to produce a beam of light and to receive return light during alignment of the telescope and a hologram configured to be positioned in the object space of the telescope and to receive the beam of light from the wavefront sensor, and the alignment system is configured to position at the image plane of the telescope either a system return optic or the wavefront sensor. The hologram includes multiple patterns including a first pattern configured to receive the beam of light from the wavefront sensor and to project a wavefront to a primary mirror of the telescope for aligning the primary mirror with respect to the hologram before a secondary mirror is positioned in the telescope, and a second pattern configured to receive the beam of light from the wavefront sensor and to project a wavefront to the secondary mirror of the telescope for aligning the secondary mirror with respect to the hologram after the secondary mirror is positioned in the telescope.

In one implementation, a method for aligning a telescope with an alignment system includes aligning a primary mirror of the telescope with respect to a hologram that is positioned in the object space of the telescope before the secondary mirror is positioned in the telescope and either a system return optic or a wavefront sensor is positioned at the image plane of the telescope. Aligning the primary mirror with respect to the hologram uses a beam of light produced by the wavefront sensor and a first pattern on the hologram that receives the beam of light and projects a wavefront to the primary mirror. The method further includes positioning the secondary mirror in the telescope and aligning the secondary mirror with respect to the hologram that is positioned in the object space of the telescope using the beam of light produced by the wavefront sensor and a second pattern on the hologram that receives the beam of light and projects a wavefront to the secondary mirror.

### BRIEF DESCRIPTION OF DRAWINGS

FIG. 1 illustrates an example of an alignment system configured to align a telescope using a wavefront sensor, a hologram (Computer Generated Holograms (CGH)) at the object plane of the telescope, and one or more system return optics at the image plane of the telescope.

FIG. 2 illustrates an example of an alignment system configured to align a telescope using a wavefront sensor at the image plane of the telescope and a hologram (CGH) at the object plane of the telescope.

FIG. 3 illustrates one possible pattern layout of the CGH for use with the alignment system shown in FIG. 1.

FIG. 4 schematically illustrates the setup of the alignment system with respect to the telescope using the CGH from FIG. 3.

FIG. 5 schematically illustrates alignment of the telescope using the alignment system with the CGH from FIG. 3.

FIG. 6 schematically illustrates alignment of the telescope using both the first and zero-orders from the CGH in the alignment system, which includes multiple system return optics.

FIG. 7 illustrates one possible pattern layout of the CGH for use with the alignment system shown in FIG. 2.

FIG. 8 schematically illustrates the setup of the alignment system with respect to the telescope using the CGH from FIG. 7.

FIG. 9 schematically illustrates alignment of the telescope using the alignment system with the CGH from FIG. 7.

FIG. 10 illustrates one possible pattern layout of the CGH for use with the alignment system shown in FIG. 1.

FIG. 11 schematically illustrates the setup of the alignment system with respect to the telescope using the CGH from FIG. 10.

FIG. 12 is a flow chart illustrating a method of aligning a telescope with an alignment system, as discussed herein.

### DETAILED DESCRIPTION

Telescope alignment is a critical process for accurate tracking and observation of objects. Alignment systems ensure the telescope's optics and mount are properly oriented. As noted above, conventional telescope system alignment methods typically requires a significant amount of data to be collected and analyzed in order to achieve correct alignment. One particular difficulty in the alignment process, for example, is field dependent astigmatism, which allows good performance at one field angle, but inferior or unsatisfactory performance at other field angles.

A recent improvement to the telescope system alignment process uses two Computer Generated Holograms (CGHs) to aid in the alignment. One of the CGHs is used in the telescope object space, while the other CGH is in the image space. The use of two CGHs in this manner has been found to be useful for aligning many systems, and in particular telescope systems with large entrance pupils, e.g., larger than the standard CGH.

The use of multiple CGH's, however, is attended by a high cost as well as multiple alignment steps, which may be complicated and time consuming. Additionally, many telescopes are not well suited for an alignment approach that uses multiple CGHs. For example, some telescopes are configured for illumination from the object space and are not easily adapted for alignment purposes using illumination from the image plane with an interferometer (e.g., testing telescope performance with the image detector array in place).

An alignment system, as discussed herein, uses a wavefront sensor, along with a single computer generated hologram (CGH), sometimes referred to herein as a hologram, positioned in the object space of a telescope for alignment. In some implementations, the CGH is transmissive and a system return optic, such as a reflective sphere, convex optic, concave optic, or flat optic, is positioned at the image plane of the telescope for alignment. In some implementations, the CGH may be reflective and the wavefront sensor is positioned at the image plane of the telescope for alignment. When the entrance pupil of the telescope fits within the write area of a CGH, for example, the simplified alignment solution, e.g., with a single CGH, may be used to save cost and setup time.

When aligning a telescope with a wavefront sensor, the use of a single CGH at the input to the telescope, in object space, enables the user to ensure that the chief ray angle of the input wavefront is aligned to the primary mirror axis. Additionally, the CGH may be used to ensure that a system return optic, used to retroreflect the rays back through the telescope and to the wavefront sensor, is located along the primary mirror axis and is at the correct distance from the primary mirror vertex. With the input wavefront and system return optic properly aligned to the primary mirror the secondary mirror can be aligned to the primary mirror via a simple measurement of the telescope wavefront at this single field angle. The resulting alignment of the secondary mirror is constrained such that the telescope performance at other field angles will be acceptable.

While this principle is suitable for the purpose of aligning an on-axis telescope, this basic principle can readily be adapted for use on off-axis optical systems and even optical systems using freeform mirrors. Additionally, the use of the single CGH method can be designed and used to align a telescope with corrective aft optics in place, which is not possible in other alignment methods. Accordingly, the single CGH alignment system can be designed for either option, with or without corrective optics.

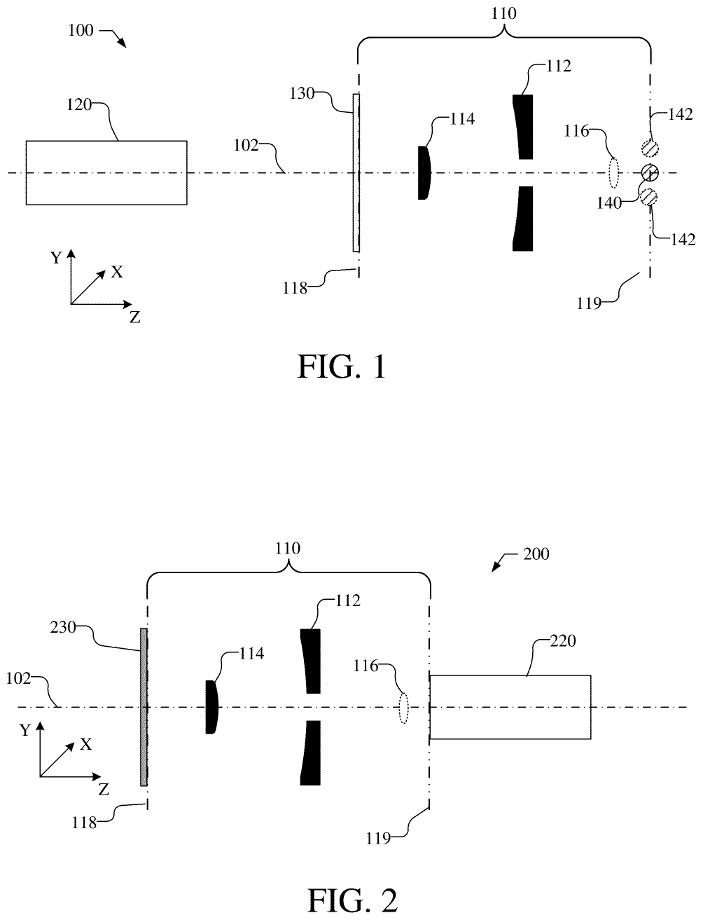

FIG. 1 illustrates an example of an alignment system 100 configured to align a telescope 110, illustrated with a primary mirror 112 and a secondary mirror 114, in some implementations, the telescope 110 may further include aft optics, illustrated by lens 116. The telescope 110, for example, may be an on-axis telescope such as a Ritchey-Chretien or Cassegrain telescope, but the alignment system 100 may be configured for use with other types of telescopes or other optical systems.

The alignment system 100 includes a wavefront sensor 120, a single transmissive CGH 130 positioned in object space 118 of the telescope 110, e.g., near the entrance pupil of the telescope 110, and a system return optic 140 positioned at the image plane 119 of the telescope 110. The entrance pupil is sometimes coincident with the primary mirror 112 or at the plane of the secondary mirror 114, and accordingly, the CGH 130 sometimes may not be located coincident with the entrance pupil. The wavefront sensor 120, for example, may be an interferometer, Shack-Hartmann wavefront sensor, or other phase sensitive device. The wavefront sensor 120, for example, may produce a collimated beam of light or diverging beam of light that is received and transmitted by the CGH 130. The CGH may be manufactured specifically for the telescope 110, as discussed herein, and produced onto (in cooperation with) a flat glass substrate or optical plate, which is mounted into a dedicated kinematic fixture. The system return optic 140 may be a reflective optic, such as a reflective sphere, convex optic, concave optic, flat optic, or other appropriate shape, that is used to return light through the telescope 110 and the CGH 130 to be detected by the wavefront sensor 120. In some implementations, one or more optional system return optics 142 may be positioned off axis at the image plane 119.

As discussed herein, during alignment, the wavefront sensor 120 and CGH 130 are positioned with respect to each other along the optical axis 102, e.g., with axes of the wavefront sensor 120 and CGH 130 aligned or the axis of wavefront sensor 120 may be tilted relative to the axis of the CGH 130. In some implementations, the CGH 130 may be an integral part of the wavefront sensor 120, e.g., using back-reflection off of the patterned surface of the CGH 130 to serve as a Fizeau reference wavefront, and in such an implementation, the wavefront sensor 120 and CGH 130 are already aligned.

The primary mirror 112 is then aligned with respect to the CGH 130, e.g., along 5 degrees of freedom, including x, y, z, and tilt about the x and y axes, without the presence of the secondary mirror 114. The system return optic 140 is aligned with respect to the CGH 130 along 3 degrees of freedom (x, y, z) or 5 degrees of freedom (x, y, z, and tilt along the x and y axes). The secondary mirror 114 is added to the system and aligned with respect to the CGH, again along 5 degrees of freedom (x, y, z, and tilt along the x and y axes).

FIG. 2 illustrates another example of an alignment system 200 configured to align a telescope 110, similar to the telescope shown in FIG. 1, like designated elements being the same.

The alignment system 200 in FIG. 2 includes a wavefront sensor 220, which may be similar to wavefront sensor 120 shown in FIG. 1 but that is positioned at or near the image plane 119 of the telescope 110, and a single reflective CGH 230 positioned in the object space 118 of the telescope 110, e.g., near the entrance pupil of the telescope 110. The CGH 230 may be similar to CGH 130 shown in FIG. 1, but is reflective. With placement of the wavefront sensor 220 at the image plane 119 of the telescope and the use of a reflective CGH 230, the use of a system return optic, such as system return optic 140 shown in FIG. 1, is obviated.

As discussed herein, in some implementations, during alignment the wavefront sensor 220 and CGH 230 are aligned with respect to each other along the optical axis 102. The primary mirror 112 is then aligned with respect to the CGH 230, e.g., along 5 degrees of freedom, including x, y, z, and tilt about the x and y axes, without the presence of the secondary mirror 114. The secondary mirror 114 is added to the system and aligned with respect to the CGH, again along 5 degrees of freedom (x, y, z, and tilt about the x and y axes).

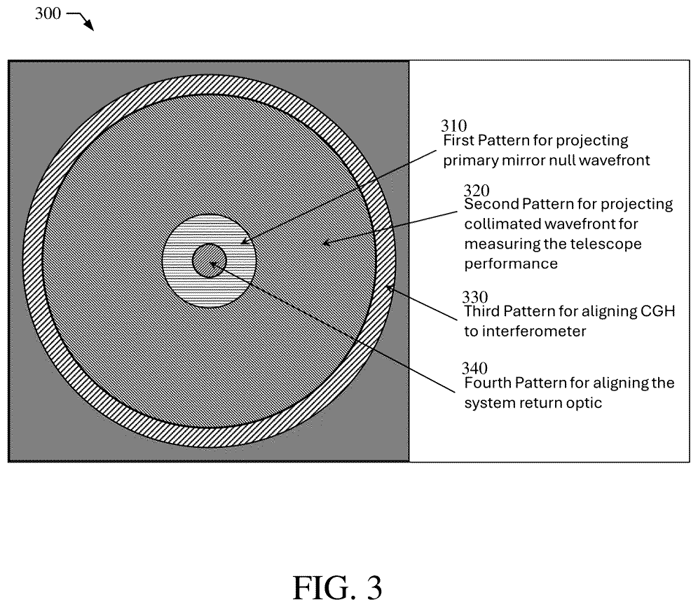

The use of multiple patterns on a single CGH enables the coalignment of individual optical components and/or wavefronts. FIG. 3 illustrates one possible pattern layout of the CGH 300, and the individual patterns listed are described herein in detail.

For the purposes of aligning a telescope a CGH 300 can be designed to have a first pattern 310 to project a wavefront which directly measures the surface of the primary mirror.

The CGH 300 will also have a second pattern 320 to project a collimated (or nearly collimated) wavefront that is parallel to the axis of the first wavefront. The wavefront from this second pattern 320 is used to measure the wavefront of the telescope as the telescope gets aligned and measures the telescope's performance. As some telescopes are designed such that they will not create a perfect wavefront without the use of additional optics on the back end of the system it can be advantageous to design this second pattern 320 to produce a projected wavefront that is not perfectly collimated, but will instead have compensating aberrations to correct the telescope wavefront in the absence of said additional back end optics.

The CGH 300 may have a third pattern 330 which may be used to align the CGH 300 to the wavefront sensor by retroreflecting the wavefront incident over this pattern when properly aligned. In some implementations, the CGH may be an integral part of the wavefront sensor, e.g., serving as a Fizeau reference, and in such an implementation, the third pattern 330 on the CGH 300 is unnecessary.

The CGH 300 can also have a fourth pattern 340 to project a wavefront which can be used to align a system return optic used to return the telescope alignment wavefront produced by the second pattern.

In some implementations, for optimal performance, the CGH should be at least as large as the input diameter of the telescope to be aligned. Currently, CGHs are most commonly made on six inch substrates. Accordingly, an alignment system, as discussed herein, with a CGH of approximately six inches is most applicable to telescopes with an aperture of less than six inches. CGHs can be, and have been, made on larger substrates, e.g., as large as twenty-seven inches across. The alignment system may use a CGH on such larger substrates for alignment of telescopes with correspondingly large input aperture. Additionally, an alignment system may use a CGH that is smaller than the input diameter of the telescope if any resulting loss in accuracy and efficiency is acceptable.

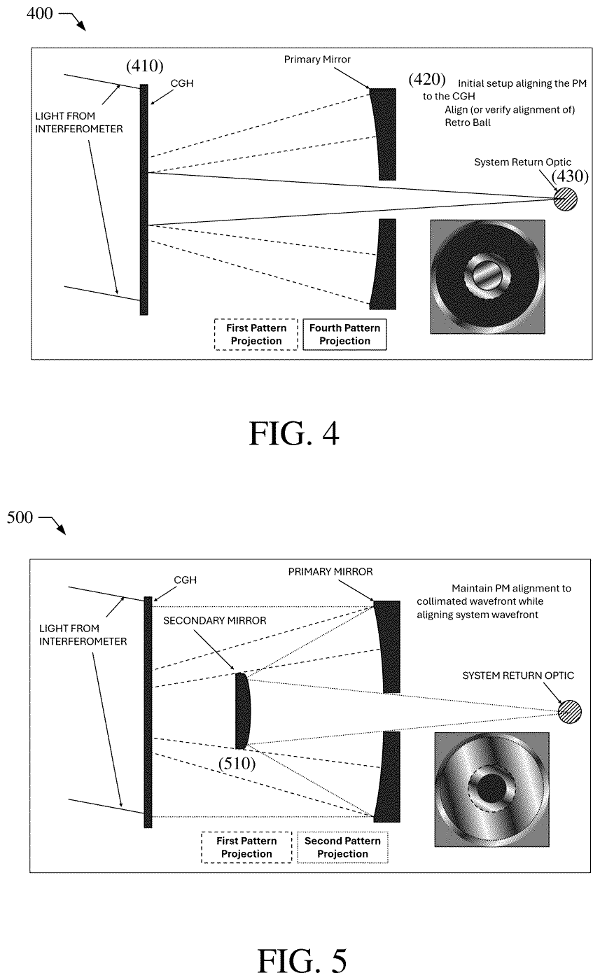

The following paragraphs describe how the alignment system is used in one implementation. FIGS. 4 and 5 schematically illustrate, respectively, the setup 400 of the alignment system with respect to the telescope and alignment 500 of the telescope using the alignment system.

In practice, the first step (410) is to align the CGH to the wavefront sensor using the third, retroreflecting, pattern. The primary mirror is then placed in the path of the wavefronts projected from the CGH and is aligned to the first pattern (420). Nulling the power in the returned wavefront sets the primary mirror in the correct location along the axis of the projected wavefront, and sets the CGH in the object space of the telescope. Nulling the tilt and coma in the wavefront sets the tilt and centering of the axis of the primary mirror to be aligned to the axis of the projected wavefront. With tilt, power, and coma of the return wavefront nulled the primary mirror is in the correct location relative to the CGH.

In some implementations, e.g., depending on alignment sensitivity, the system return optic may be aligned (430) by mechanical means, e.g., without requiring a wavefront measurement, in which case the system return optic may be aligned before or after aligning the primary mirror. In some implementations, however, a wavefront measurement may be used to align the system return optic (430), in which case, the system return optic is aligned after aligning the primary mirror. The CGH may be fabricated with the fourth described pattern for aligning a system return optic using a wavefront measurement. This system return optic may be a sphere, either concave or convex, and the projected wavefront from the fourth pattern is spherical with the center of curvature coincident with the telescope focus for the on-axis image location. By nulling the return wavefront from the system return optic, the system return optic will be in the correct location, i.e., at the image plane, for use during telescope alignment. It is necessary to align this return optic prior to putting the secondary mirror in place as the secondary mirror will block the projected wavefront from the fourth pattern in the CGH before it gets to the system return optic. The CGH can be designed to align the system using some other telescope field angle for which the fourth pattern would be designed to place the center of curvature of the projected wavefront at a location to match the image location of said field angle.

With the primary mirror and the system return optic both aligned to the CGH as illustrated in setup 400 in FIG. 4, alignment 500 of the telescope shown in FIG. 5 includes moving the secondary mirror in position between the primary mirror and the CGH (510). The secondary mirror alignment is manipulated to position it such that the wavefront projected from the second pattern is directed to reflect off the system return optic and back through the telescope and CGH to form a null wavefront at the wavefront sensor. Nulling the wavefront tilt and coma sets the centering and tilt of the secondary mirror and nulling the power sets the position of the mirror along the telescope axis. Once this wavefront is nulled the telescope is properly aligned.

This process results in a telescope that is properly aligned such that the alignment condition of the secondary mirror will not contribute to the field dependent astigmatism of the telescope.

The process described above is directly applicable to a traditional on-axis telescope such as a Ritchey-Chretien or Cassegrain telescope. With small modifications to the descriptions, the basic concepts described are also applicable to other types of telescope designs.

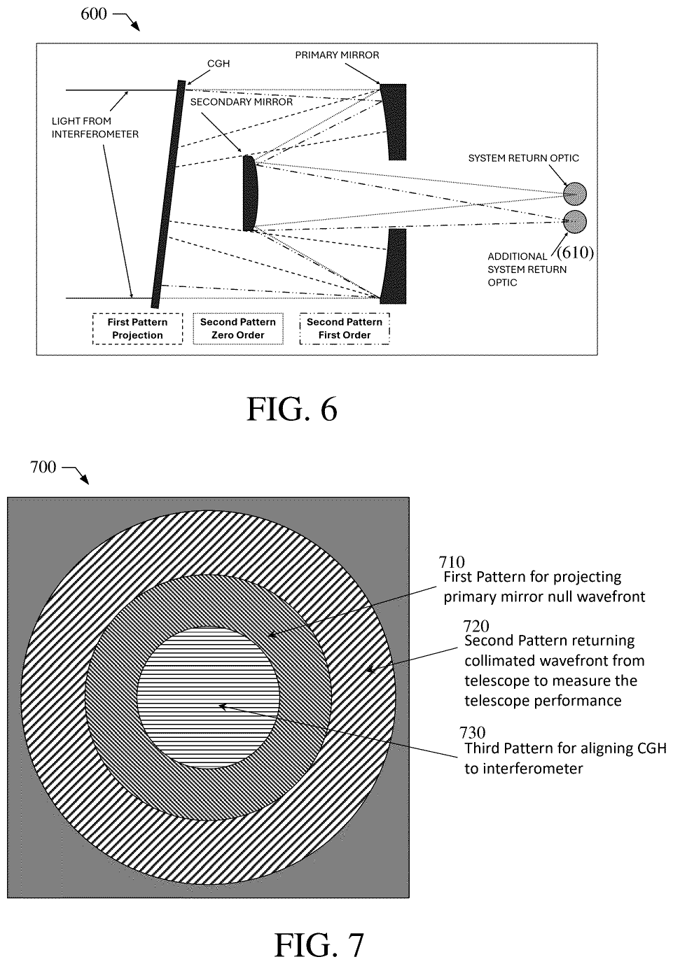

Another embodiment, illustrated in FIG. 6, leverages the transmission of both the first and zero-orders of the collimated wavefront from the wavefront sensor through the second pattern of the CGH for two different telescope field angles. In this configuration, the hologram would be designed such that when the primary mirror was properly aligned to the CGH, the zero-order transmission through the CGH would be propagating in a direction parallel to the primary mirror axis. The first-order diffraction wavefront through the second pattern would propagate at a specific angle that will have been selected based on the telescope operating field angles (see FIG. 6).

An optional feature to add to this embodiment would be to interlace an additional pattern into the fourth pattern that would enable the alignment of an additional system return optic to work with the additional field angle illuminated by the first-order diffraction wavefront (610). This is not strictly necessary but could be beneficial in shortening alignment time.

It is possible to design the second pattern such that the first-order diffraction illuminates the telescope on axis (as shown in FIG. 5) while the zero-order illuminates some other field angle. However, for most systems it is advantageous to use the first-order to illuminate the off-axis field angle as the telescope will typically have field dependent aberrations in the wavefront which can be corrected by the CGH prescription (the zero-order cannot be corrected in this way).

The advantage of including this ability to measure the telescope at an off-axis field angle in addition to the on-axis field is that the final system alignment condition can be verified. That is to say that while this system offers a method to align the system using only the on-axis field, in practice it is possible that a stack-up of errors and uncertainties for a very sensitive system can result in an alignment condition where the field performance does not meet specifications. This embodiment allows the telescope performance at this off-axis field angle to be verified without disturbing the hardware and therefore reduces performance and schedule risks.

It should also be noted that the CGH could be rotated about the primary mirror axis to any number of clocking angles and the test will still work (the additional system return optic needs to follow or more system return optics would need to be added). This rotation would sweep the off-axis field angle around the system axis thus providing additional absolute field angles (+X vs −X and +Y vs −Y) to be tested. This is advantageous if the measurement of the system performance at the first off-axis field angle indicates that the system does not meet the performance specifications. Measuring at multiple field angles allows for a positive identification of the source of the performance issue.

In cases where the field dependent aberrations are not so large as to require compensation in the CGH prescription, and the CGH is designed to have the zero-order transmission through the second pattern illuminate the telescope on axis, and the first-order transmission illuminates a chosen field angle, the minus-first-order can be used to test an additional field angle, thus providing a total of three different field angles to be tested without the need for rotating the CGH.

In both embodiments, the CGH may be tilted relative to the incoming wavefront. This is a common practice to eliminate unwanted reflections from the CGH surfaces to the wavefront sensor. It is not strictly required.

In some implementations, a collimated input wavefront from the wavefront sensor may be used, as illustrated in FIGS. 4, 5, and 6. It would also be possible to illuminate the CGH with a diverging or converging wavefront. The second embodiment, illustrated in FIG. 6, would not be able to use the zero-order transmission for system alignment in this case. In this case an off-axis field angle could be accommodated by interlacing an additional pattern into the second pattern. Taking this approach requires more effort in the CGH design and also comes at a cost of diffraction efficiency. The benefit of taking this approach would be that a telescope with an entrance aperture larger than the diameter of the wavefront sensor could be accommodated by the expanding beam of a diverging wavefront.

The wavefront sensor in the alignment system may be an interferometer, but the alignment system need not be constrained to the use of interferometers. There are other system wavefront measurement approaches, such as Shack-Hartmann wavefront sensors for example, that could be used with a CGH to accomplish the same alignment and verification results.

While the discussion above concentrated on the alignment of telescopes, the alignment system could also be applied to optical systems used for other purposes.

In one implementation, instead of being used in transmission mode, as illustrated in FIGS. 4, 5, and 6, a CGH may be used in reflection mode. In this implementation, the wavefront sensor would be designed to project the test wavefront from image space and the CGH would be placed in object space, e.g., as illustrated in FIG. 2.

FIG. 7 illustrates one possible pattern layout of the CGH 700 for use in reflection mode, and the individual patterns listed are described herein in detail. Similar to the pattern layout illustrated in FIG. 3, the CGH 700 will have a first pattern 710 designed to project a wavefront which directly measures the surface of the primary mirror for aligning the CGH with the primary mirror, a second pattern 720 used in measurement of the telescope wavefront during alignment of the secondary mirror and measurement of the telescope performance, and a third pattern 730 used to align the wavefront sensor with the CGH by retroreflecting the wavefront incident over this pattern when properly aligned.

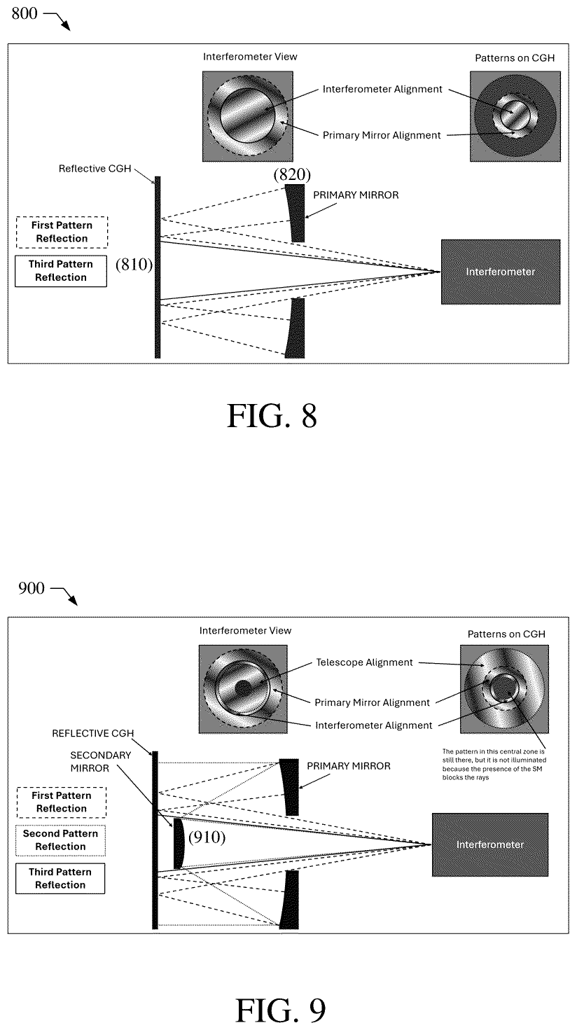

FIGS. 8 and 9 schematically illustrate, respectively, the setup 800 of the alignment system with respect to the telescope and alignment 900 of the telescope using the alignment system. In practice the wavefront sensor, CGH and primary mirror would all be roughly placed relative to one another. The CGH would then be aligned to the wavefront sensor (810) to null out the wavefront returned from the third pattern. The primary mirror would then be aligned (820) to the CGH using the wavefront diffracted (in reflection) off the first pattern. Once the primary mirror is aligned to this wavefront from the CGH, the primary mirror will be positioned such that the primary mirror axis is appropriately positioned relative to the CGH design axis and the wavefront sensor, and the CGH and wavefront sensor will be positioned in the object space and image plane, respectively, of the telescope. The secondary mirror is then placed into the telescope in roughly the correct location and is finely aligned (910) to the primary mirror by nulling the wavefront which is returned from the second pattern of the CGH. It should be noted that the CGH can be designed so that the second pattern is used in zero order reflection or it can be designed such that the CGH substrate is tilted relative to the CGH design axis and therefore first order diffraction (in reflection) of the second pattern is used.

The wavefront sensor used for alignment, as illustrated in FIGS. 8 and 9, may be an interferometer, but other system wavefront measurement approaches may be used, such as Shack-Hartmann wavefront sensors for example, to accomplish the same alignment and verification results using the same CGH.

The diagrams have all indicated that the rays in image space are propagating to or from a point indicating a spherical wavefront in image space. While this is common for many telescopes, it is not a confinement for telescope design. The alignment systems discussed herein can be used with telescopes which are designed to have a spherical wavefront, collimated wavefront, or any form of aspheric wavefront in image space.

While the discussion above concentrated on the alignment of telescopes, the alignment systems could also be applied to optical systems used for other purposes.

In one implementation, the tilt of the secondary mirror is controlled instead of controlling the location of the system return optic.

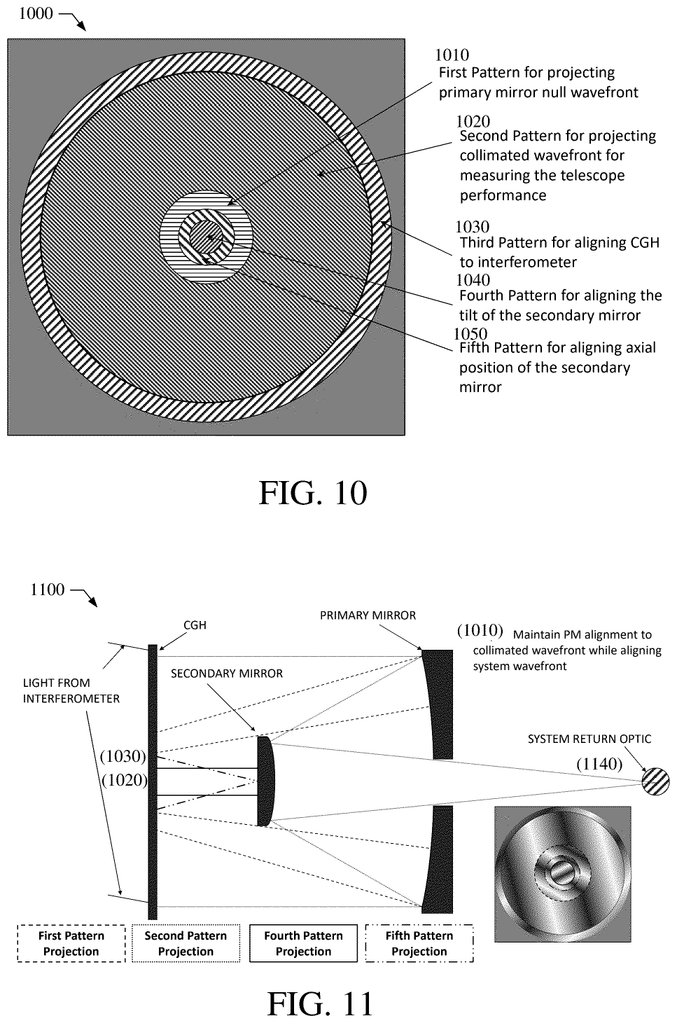

FIG. 10 illustrates one possible pattern layout of the CGH 1000 for an implementation in which the tilt of the secondary mirror is controlled, and the individual patterns listed are described herein in detail. Similar to the pattern layout illustrated in FIG. 3, the CGH 1000 will have a first pattern 1010 designed to project a wavefront which directly measures the surface of the primary mirror for aligning the CGH 1000 with the primary mirror, a second pattern 1020 used in measurement of the telescope wavefront during alignment of the secondary mirror and measurement of the telescope performance, and a third pattern 1030 may be used to align the wavefront sensor with the CGH 1000 by retroreflecting the wavefront incident over this pattern 1030 when properly aligned. In some implementations, the CGH 1000 may be an integral part of the wavefront sensor, e.g., serving as a Fizeau reference, and in such an implementation, the third pattern 1030 on the CGH is unnecessary. A fourth pattern 1040 which projects an alignment pattern to the backside surface of the secondary mirror for aligning the tilt of the secondary mirror. This alignment pattern 1040 can project a collimated wavefront that is aligned to the primary mirror axis. When using this configuration, the tilt of the secondary mirror axis relative to its back surface has to be known. An optional fifth pattern 1050 could be used to focus on the back surface of the secondary mirror to set the distance between the secondary mirror and the primary mirror. When using this configuration, the center thickness of the secondary mirror must be known.

FIG. 11 schematically illustrates the setup 1100 of the alignment system with respect to the telescope. When aligning a system using the CGH 1000 from FIG. 10, the primary mirror is aligned (1110) as it is in the previous descriptions; the tilt of the secondary mirror is set (1120) by nulling the return from the fourth pattern; the position of the secondary mirror along the axis is set (1130) by nulling the power in the fifth pattern; nulling the coma in the system wavefront sets the centering of the secondary mirror; the system return optic position is set (1140) by nulling the tilt and the power in the system wavefront.

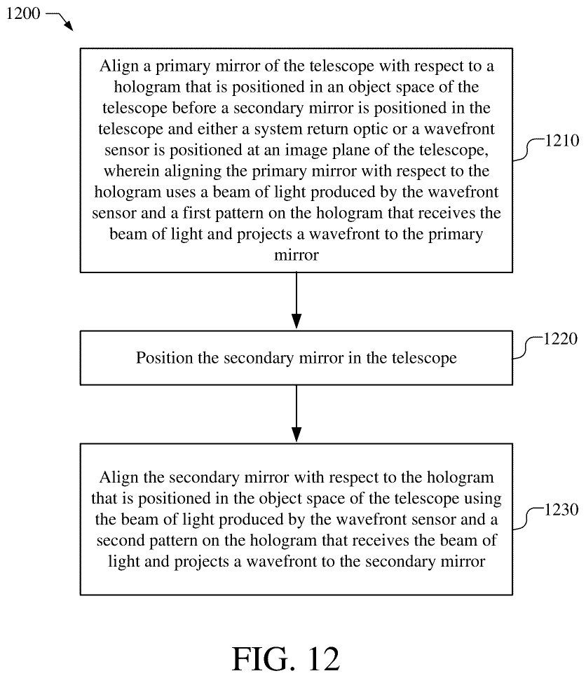

FIG. 12 is a flow chart 1200 illustrating a method of aligning a telescope with an alignment system, such as alignment systems 100 or 200 shown in FIGS. 1 and 2, and as discussed herein with respect to FIGS. 3-11.

At block 910, a primary mirror of the telescope is aligned with respect to a hologram that is positioned in an object space of the telescope before a secondary mirror is positioned in the telescope and either a system return optic or a wavefront sensor is positioned at an image plane of the telescope, where aligning the primary mirror with respect to the hologram uses a beam of light produced by the wavefront sensor and a first pattern on the hologram that receives the beam of light and projects a wavefront to the primary mirror. For example, the hologram may be a reference optic in the wavefront sensor.

At block 920, the secondary mirror is positioned in the telescope.

At block 930, the secondary mirror is aligned with respect to the hologram that is positioned in the object space of the telescope using the beam of light produced by the wavefront sensor and a second pattern on the hologram that receives the beam of light and projects a wavefront to the secondary mirror.

In some implementations, the method may further include aligning the wavefront sensor and the hologram using a beam of light produced by the wavefront sensor and a third pattern on the hologram that receives the beam of light from the wavefront sensor and retroreflects a wavefront to the wavefront sensor for aligning the hologram with respect to the wavefront sensor.

In some implementations, the second pattern projects the wavefront to the secondary mirror via the primary mirror of the telescope.

In some implementations, the system return optic is positioned at the image plane of the telescope and the hologram is transmissive.

In some implementations, the method may further include aligning the system return optic with respect to the hologram before the secondary mirror is positioned in the telescope and after aligning the primary mirror with respect to the hologram, where aligning the system return optic with respect to the hologram uses the beam of light produced by the wavefront sensor and a third pattern on the hologram that receives the beam of light and projects a wavefront to the system return optic.

In some implementations, the wavefront sensor is positioned at the image plane of the telescope and the hologram is reflective.

In some implementations, the second pattern diffracts the beam of light and projects a zero-order and a first-order of the wavefront to the secondary mirror via the primary mirror of the telescope for two different telescope field angles, and aligning the secondary mirror with respect to the hologram may use the two different telescope field angles. For example, the zero-order of the wavefront may propagate parallel to an axis of the primary mirror and the first-order of the wavefront may propagate at a selected telescope field angle. For example, the system return optic may be positioned on axis at the image plane of the telescope and at least one additional system return optic is positioned off axis at the image plane of the telescope. In some implementations, the method may further include comprises aligning the system return optic and the at least one additional system return optic with respect to the hologram before the secondary mirror is positioned in the telescope and after aligning the primary mirror with respect to the hologram, where aligning the system return optic and the at least one additional system return optic with respect to the hologram uses the beam of light produced by the wavefront sensor and a third pattern on the hologram that comprises interlaced patterns configured to receive the beam of light from the wavefront sensor and to project wavefronts to the system return optic and the at least one additional system return optic. In some implementations, the method may further include rotating the hologram about an axis of the primary mirror to measure multiple off-axis telescope field angles.

In some implementations, the second pattern is configured to project the wavefront to a backside of the secondary mirror and aligning the secondary mirror may include adjusting tilt of the secondary mirror. For example, the method may further include adjusting a position of the secondary mirror along an axis of the primary mirror using the beam of light produced by the wavefront sensor and a third pattern on the hologram that receives the beam of light and projects a wavefront to the backside of the secondary mirror. The method may further include measuring a performance of the telescope using the beam of light produced by the wavefront sensor and a third pattern on the hologram that receives the beam of light and projects a wavefront to the secondary mirror of the telescope via the primary mirror.

Those skilled in the art will understand that the preceding implementations of the present disclosure provide the foundation for numerous alternatives and modifications that are also deemed within the scope of the present disclosure. The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. An alignment system for aligning a telescope, the alignment system comprising:
a wavefront sensor configured to produce a beam of light and to receive return light during alignment of the telescope; and
a hologram configured to be positioned in an object space of the telescope and to receive the beam of light from the wavefront sensor, and the alignment system is configured to position at an image plane of the telescope either a system return optic or the wavefront sensor, the hologram comprises multiple patterns comprising:
a first pattern configured to receive the beam of light from the wavefront sensor and to project a wavefront to a primary mirror of the telescope for aligning the primary mirror with respect to the hologram before a secondary mirror is positioned in the telescope; and
a second pattern configured to receive the beam of light from the wavefront sensor and to project a wavefront to the secondary mirror of the telescope for aligning the secondary mirror with respect to the hologram after the secondary mirror is positioned in the telescope.

2. The alignment system of claim 1, wherein the multiple patterns of the hologram further comprise a third pattern configured to receive the beam of light from the wavefront sensor and to retroreflect a wavefront to the wavefront sensor for aligning the hologram with respect to the wavefront sensor.

3. The alignment system of claim 1, wherein the hologram is a reference optic in the wavefront sensor.

4. The alignment system of claim 1, wherein the second pattern is configured to project the wavefront to the secondary mirror via the primary mirror of the telescope.

5. The alignment system of claim 1, wherein the alignment system comprises the system return optic configured to be positioned at the image plane of the telescope, and wherein the hologram is transmissive.

6. The alignment system of claim 5, wherein the multiple patterns of the hologram further comprise a third pattern configured to receive the beam of light from the wavefront sensor and to project a wavefront to the system return optic for aligning the system return optic with respect to the hologram before the secondary mirror is positioned in the telescope.

7. The alignment system of claim 1, wherein the wavefront sensor is configured to be positioned at the image plane of the telescope, and wherein the hologram is reflective.

8. The alignment system of claim 1, wherein the second pattern diffracts the beam of light and projects a zero-order and a first-order of the wavefront to the secondary mirror via the primary mirror of the telescope for two different telescope field angles.

9. The alignment system of claim 8, wherein the zero-order of the wavefront propagates parallel to an axis of the primary mirror and the first-order of the wavefront propagates at a selected telescope field angle.

10. The alignment system of claim 8, wherein the alignment system comprises the system return optic configured to be positioned on axis at the image plane of the telescope and at least one additional system return optic configured to be positioned off axis at the image plane of the telescope.

11. The alignment system of claim 10, wherein the multiple patterns of the hologram further comprise a third pattern comprising interlaced patterns configured to receive the beam of light from the wavefront sensor and to project wavefronts to the system return optic and the at least one additional system return optic for alignment with respect to the hologram before the secondary mirror is positioned in the telescope.

12. The alignment system of claim 8, wherein the hologram is configured to be rotated about an axis of the primary mirror to measure multiple off-axis telescope field angles.

13. The alignment system of claim 1, wherein the second pattern is configured to project the wavefront to a backside of the secondary mirror to adjust tilt of the secondary mirror.

14. The alignment system of claim 13, wherein the multiple patterns of the hologram further comprise a third pattern configured to receive the beam of light from the wavefront sensor and to project a wavefront to the backside of the secondary mirror to adjust a position of the secondary mirror along an axis of the primary mirror.

15. The alignment system of claim 13, wherein the multiple patterns of the hologram further comprise a third pattern configured to receive the beam of light from the wavefront sensor and to project a wavefront to the secondary mirror of the telescope via the primary mirror for measuring performance of the telescope.

16. A method for aligning a telescope with an alignment system, the method comprising:
aligning a primary mirror of the telescope with respect to a hologram that is positioned in an object space of the telescope before a secondary mirror is positioned in the telescope and either a system return optic or a wavefront sensor is positioned at an image plane of the telescope, wherein aligning the primary mirror with respect to the hologram uses a beam of light produced by the wavefront sensor and a first pattern on the hologram that receives the beam of light and projects a wavefront to the primary mirror;
positioning the secondary mirror in the telescope; and
aligning the secondary mirror with respect to the hologram that is positioned in the object space of the telescope using the beam of light produced by the wavefront sensor and a second pattern on the hologram that receives the beam of light and projects a wavefront to the secondary mirror.

17. The method of claim 16, the method further comprises aligning the wavefront sensor and the hologram using a beam of light produced by the wavefront sensor and a third pattern on the hologram that receives the beam of light from the wavefront sensor and retroreflects a wavefront to the wavefront sensor for aligning the hologram with respect to the wavefront sensor.

18. The method of claim 16, wherein the hologram is a reference optic in the wavefront sensor.

19. The method of claim 16, wherein the second pattern projects the wavefront to the secondary mirror via the primary mirror of the telescope.

20. The method of claim 16, wherein the system return optic is positioned at the image plane of the telescope and the hologram is transmissive.

21. The method of claim 20, the method further comprises:
aligning the system return optic with respect to the hologram before the secondary mirror is positioned in the telescope and after aligning the primary mirror with respect to the hologram, wherein aligning the system return optic with respect to the hologram uses the beam of light produced by the wavefront sensor and a third pattern on the hologram that receives the beam of light and projects a wavefront to the system return optic.

22. The method of claim 16, wherein the wavefront sensor is positioned at the image plane of the telescope and the hologram is reflective.

23. The method of claim 16, wherein the second pattern diffracts the beam of light and projects a zero-order and a first-order of the wavefront to the secondary mirror via the primary mirror of the telescope for two different telescope field angles, and aligning the secondary mirror with respect to the hologram uses the two different telescope field angles.

24. The method of claim 23, wherein the zero-order of the wavefront propagates parallel to an axis of the primary mirror and the first-order of the wavefront propagates at a selected telescope field angle.

25. The method of claim 23, wherein the system return optic is positioned on axis at the image plane of the telescope and at least one additional system return optic is positioned off axis at the image plane of the telescope.

26. The method of claim 25, the method further comprises aligning the system return optic and the at least one additional system return optic with respect to the hologram before the secondary mirror is positioned in the telescope and after aligning the primary mirror with respect to the hologram, wherein aligning the system return optic and the at least one additional system return optic with respect to the hologram uses the beam of light produced by the wavefront sensor and a third pattern on the hologram that comprises interlaced patterns configured to receive the beam of light from the wavefront sensor and to project wavefronts to the system return optic and the at least one additional system return optic.

27. The method of claim 23, further comprising rotating the hologram about an axis of the primary mirror to measure multiple off-axis telescope field angles.

28. The method of claim 16, wherein the second pattern is configured to project the wavefront to a backside of the secondary mirror and aligning the secondary mirror comprises adjusting tilt of the secondary mirror.

29. The method of claim 28, further comprising adjusting a position of the secondary mirror along an axis of the primary mirror using the beam of light produced by the wavefront sensor and a third pattern on the hologram that receives the beam of light and projects a wavefront to the backside of the secondary mirror.

30. The method of claim 28, further comprising measuring a performance of the telescope using the beam of light produced by the wavefront sensor and a third pattern on the hologram that receives the beam of light and projects a wavefront to the secondary mirror of the telescope via the primary mirror.
